(19) United States
(12) Patent Application Publication
(10) Pub. No.: US 2025/0381085 A1
(43) Pub. Date: Dec. 18, 2025

(54) MOTION CONTROL FOR ACTUATION OF SURGICAL TABLE HEIGHT

(71) Applicant: American Sterilizer Company, Mentor, OH (US)

(72) Inventors: Douglas J. Ansley, Mentor, OH (US); James A. Petrucci, Bluffton, SC (US)

(21) Appl. No.: 19/235,211

(22) Filed: Jun. 11, 2025

Related U.S. Application Data
(60) Provisional application No. 63/661,244, filed on Jun. 18, 2024.

(51) Int. Cl. A61G 13/08; A61G 13/04

(52) U.S. Cl. CPC A61G 13/08; A61G 13/04

(57) ABSTRACT

A surgical table with motion control and improved transitions between primary and secondary actuation systems is described. A surgical table may include: a first actuation system having at least one primary actuator powered with a primary variable speed electric motor; a second actuation system having at least two secondary actuators powered respectively with secondary variable speed electric motors; and a controller adapted to regulate positions of the primary and secondary actuators. This controller is operable to raise the tabletop by implementing logic to: control the primary variable speed electric motor based on a primary actuator deceleration profile that decreases a speed of extending the primary actuator while raising the tabletop with the secondary actuators; and control the secondary variable speed electric motors based on a secondary actuator acceleration profile that increases a speed of extending the secondary actuators while raising the tabletop with the primary actuator.

### CLAIM OF PRIORITY

This patent application claims the benefit of U.S. Provisional Patent Application No. 63/661,244, filed Jun. 18, 2024, which is incorporated by reference herein in its entirety

### BACKGROUND

Users of a surgical table—also referred to as an operating table—often want such a table to offer the largest possible range of tabletop heights and the largest possible range of adjustable tabletop rotation for a variety of users, patients, and procedures. The adjustable tabletop height of a surgical table is provided by at least one actuation system that mechanically causes the tabletop to raise and lower. The adjustable tabletop rotation of a surgical table is provided by the same or an additional actuation system that pivots the table about an axis in longitudinal and/or transverse directions. The longitudinal rotation of the tabletop may be used to move the patient into a supine position (e.g., flat on their back) where the patient's head is angled down below their abdomen, known as the Trendelenburg or “Trend” position. Similarly. the longitudinal rotation of the tabletop may be used to move the patient into a supine position where the patient's head is raised above their abdomen, known as a reverse Trendelenburg or “reverse Trend” position.

Many modern surgical tables are designed to achieve a minimum height of 22 inches, a maximum height of 45 inches, and a Trendelenburg range of ±45°, or similar values and ranges. For surgical tables where a maximum height is more than twice the minimum height, the range of motion cannot be provided by a simple single-stage linear actuator. Thus, a common design approach is to use multiple actuators to achieve the desired overall height. One implementation uses a single linear actuator to provide most of the vertical stroke, referred to as primary height actuation, and a pair of linear actuators or “Trend actuators” to rotate the tabletop to provide the Trendelenburg range of motion. When the Trend actuators move in different directions, the tabletop simply rotates about a fixed axis. When the Trend actuators move in the same direction, the tabletop can raise or lower further, extending the vertical range of motion. Using multiple Trend actuators in this way to provide additional vertical travel is referred to as secondary height actuation.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a configuration of a surgical table, according to an example.

FIGS. 2A-2D illustrate aspects of a moveable framework for controlling an angle and height of a repositionable frame with a second actuation system, according to an example.

FIGS. 3A and 3B illustrate graphs of data values for tabletop height and tabletop speed, for sequential activation of a first and second actuation system, according to an example.

FIGS. 4A and 4B illustrate graphs of data values for tabletop height and tabletop speed, for overlapping activation of a first and second actuation system, according to an example.

FIG. 5 illustrates a flowchart of a method for initializing settings for overlapping activation of a first actuation system and a second actuation system, according to an example.

FIG. 6 illustrates a flowchart of a method for transitioning speeds between a first actuation system and a second actuation system in connection with overlapping actuation, according to an example.

FIG. 7 illustrates a flowchart of a method for controlling positions of a surgical table, according to an example.

FIG. 8 illustrates a block diagram of an example machine according to an example.

### DETAILED DESCRIPTION

The present disclosure describes, among other things, a motion control system for a surgical table. This motion control system is designed to identify the transition from primary to secondary height actuation, and introduce measures to provide smooth motion and progressively hand off the motion from one actuation system to the other system without delay or interruption. In an example, when a surgical table is raised and the end of travel of primary height actuation approaches, a deceleration of a primary height actuator is introduced to simultaneously overlap with the use and acceleration of at least one secondary height actuator to raise the table. In a corresponding example, when a surgical table is lowered from an elevated state that uses secondary height actuation, a deceleration of the at least one secondary height actuator is introduced to simultaneously overlap with the use and acceleration of the primary height actuator to lower the table. This combination of acceleration and deceleration of the primary and secondary actuation systems can be coordinated to provide smooth motion for patient comfort.

The present techniques for coordinating primary height actuation and secondary height actuation can be introduced while maximizing the range of vertical travel of the tabletop, to fully achieve secondary height actuation and as much Trend capability as possible at all table heights. Additionally, these height actuation techniques can be used to minimize total travel time over the full range of vertical travel by avoiding unnecessary slow-downs or dwells, and related opportunities for operator error and adverse patient effects. Accordingly, these height actuation techniques can be deployed in many arrangements of a surgical table using mechanical components already existing in the surgical table or with minimal modification.

The present techniques are described below with reference to surgical table designs that use multiple actuators and/or actuation systems (e.g., at least a primary actuation system and a secondary actuation system) to achieve the total range of vertical motion. In an example, the height actuation is achieved with use of electromechanical actuators and controllers, although other types of mechanical actuation and control may be possible. In the following examples, electromechanical actuators are controlled by microprocessors that enable sophisticated control of the motion profiles, in a more precise manner than hydraulic actuators.

Further details for coordinating the control of the multiple actuators and actuation systems are discussed below, after an introduction of an example surgical table configuration with a first (primary) actuation system and a second (secondary) actuation system. Other details of this example surgical table configuration are provided in U.S. Pat. No. 11,400,005 to Clayton et al., titled “Surgical Tables”, which is incorporated by reference herein in its entirety.

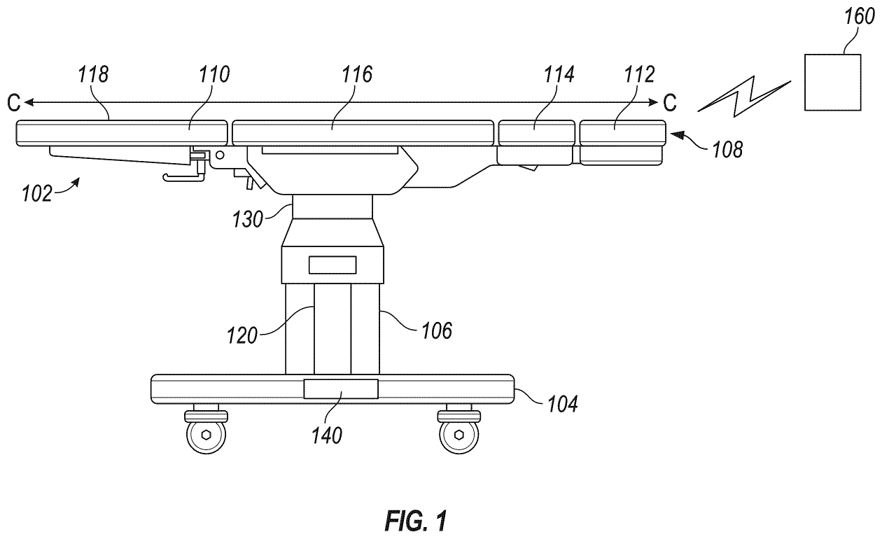

FIG. 1 depicts an example configuration of a surgical table 102, which comprises a base 104 or standing on a floor. The base 104 typically includes wheels for moving the surgical table 102 along the floor. Alternatively, the base 104 may be fixed, for example having fixed feet. A column 106 of adjustable height is provided by a first actuation system 120 that extends from the base 104 and is disposed within the column 106, with the first actuation system 120 also referred to as a primary actuation system. A tabletop 108, which provides a patient support surface 110, is supported above the column.

The surgical table 102 includes a second actuation system 130, also referred to as a secondary actuation system, for additionally raising the tabletop 108 and inclining the tabletop 108 relative to the column 106 of the first actuation system 120. The second actuation system 130 specifically can incline the tabletop 108 about transverse and longitudinal horizontal axes of the tabletop 108. Inclination about the transverse horizontal axis of the tabletop 108 is referred to in the art as “Trending”, while inclination about the longitudinal horizontal axis of the tabletop 108 is referred to in the art as “Tilting”. Compound movements also are possible, in which the tabletop 108 is inclined about both the transverse and longitudinal axes of the tabletop 108 at the same time. As used herein, the longitudinal axis of the tabletop 108 is the major axis of the tabletop 108 and the transverse axis of the tabletop 108 is the orthogonal minor axis of the tabletop 108. The longitudinal direction of the tabletop 108 is parallel to the major axis and the transverse direction of the tabletop 108 is parallel to the minor axis. That is, the transverse direction of the tabletop 108 is perpendicular to, or orthogonal to, the longitudinal direction of tabletop 108.

As depicted in FIG. 1, the tabletop 108 may be divided into a number of sections, such as a head section 112, an upper torso section 114, a lower torso section 116 and a pair of laterally adjacent leg sections 118, of which only one is shown in FIG. 1. The lower torso section 116 is coupled to the column 106. Each of the sections of the tabletop 108 provides a portion of the patient support surface 110, and each of the sections may have a respective separate mattress (not illustrated) removably fitted to the respective section. As is well known in the art, the tabletop sections can be individually moved relative to an adjacent section and some sections can be detached from the tabletop 108.

The column 106 of the first actuation system 120 may comprise a plurality of column elements that form a telescoping assembly, with telescoping assembly surrounding an actuator. The actuator may comprise an electric actuator, such as a two-stage synchronized telescopic leadscrew, or ballscrew/leadscrew combination. The lifting load can be directed entirely through the leadscrew ballscrew/leadscrew combination with no axial bearings required to support the lifting load. Alternatively, the actuator may comprise two ballscrews, or a leadscrew/ballscrew combination. Other hardware may be provided.

A controller 140 may be integrated within the surgical table 102 to provide electrical control of respective actuators of the first actuation system 120 and the second actuation system 130. Such electrical control may occur in response to manual operator (user) commands or automatically in response to system logic. The controller may coordinate multiple aspects of sensing and control for height and angle adjustment, including sensing and controlling states of the primary variable speed electric motor of the first actuation system 120, and sensing and controlling states of controlling states of the secondary variable speed electric motors of the second actuation system 130.

A user interface control 160, illustrated schematically in FIG. 1 as a wireless control, may interface with the controller 140 to provide user commands to change the height, angles, and other controllable positions of the tabletop 108. For instance, the user interface control 160 may be used to change the overall height of the tabletop 108 in response to some button or user interface control being pressed by a user. The user interface control 160 may also change the effective Trend axis to be variable within a first dimensional range and to change the location of the effective Trend axis in a direction orthogonal to the transverse axis to be variable within a first dimensional range. This user interface control 160 may be provided by a remote console or tablet having a touchscreen, indicators, buttons, dials, and other types of features to receive user input to change the position of the tabletop 108 and output status regarding the position of the tabletop 108 or other components of the surgical table 102.

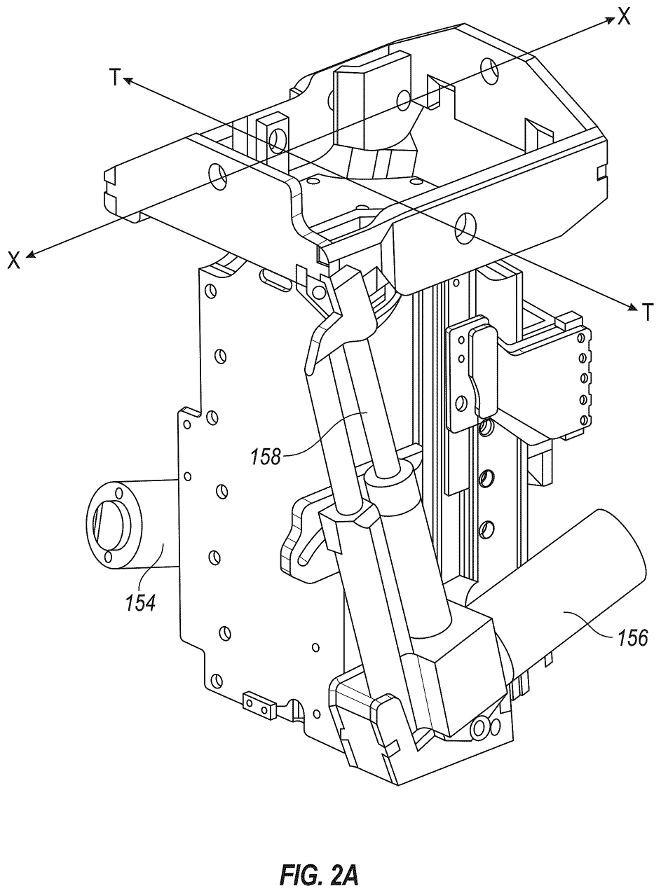

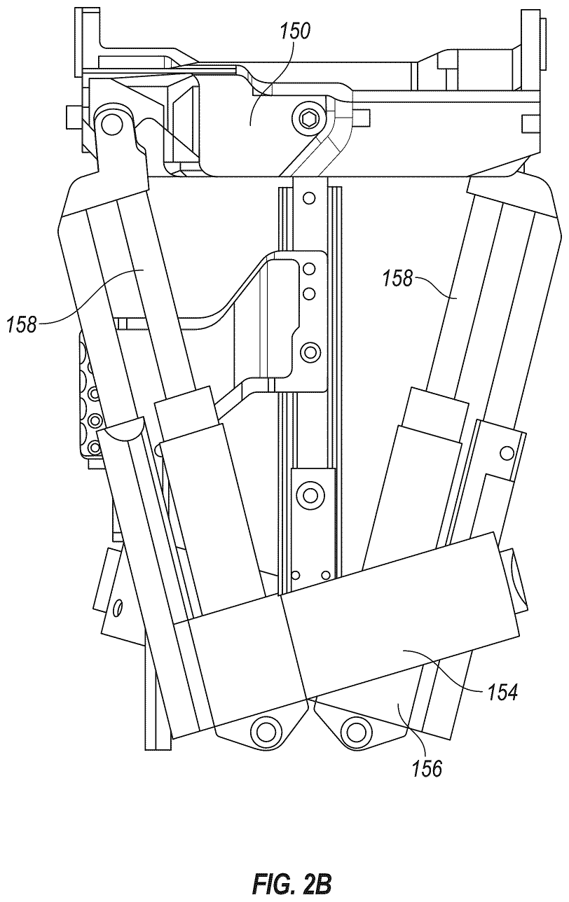

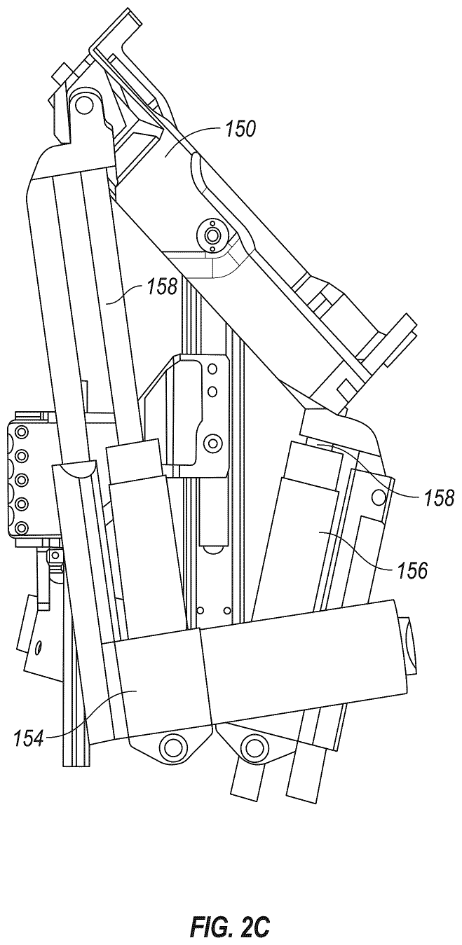

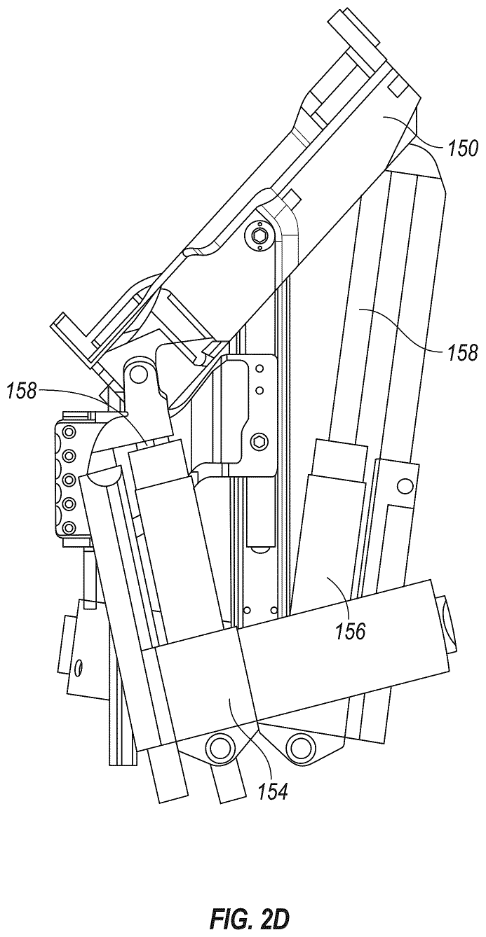

As shown in more detail in FIGS. 2A-2D, the surgical table 102 incorporates a movable framework for controlling the angle and height of a repositionable frame (the frame 150), which is hosted beneath the tabletop 108 and controlled by individual components of the second actuation system 130. For instance, the frame 150 can be rotated about a Trend axis, as the angle of inclination of the frame 150 sets the Trend angle of the tabletop 108. FIG. 2A depicts a perspective view of the frame 150 and coupled components of the second actuation system 130, including first and second actuators 154, 156 respectively, and elongate element 158 in each actuator 154, 156. FIG. 2B depicts a side view of the second actuation system 130, the first and second actuators 154, 156, and the elongate element 158, where the frame 150 is oriented in a level position, with extension of the actuators 154, 156 providing secondary height actuation beyond the primary height actuation of the column 106. FIG. 2C depicts another side view of the second actuation system 130, the first and second actuators 154, 156, and the elongate element 158, with an extension of the actuator 154 and retraction of the actuator 156 to achieve a Trend position. FIG. 2D depicts another, opposite side view of the second actuation system 130, the first and second actuators 154, 156, and the elongate element 158, with an extension of the actuator 156 and retraction of the actuator 154 to achieve a reverse Trend position.

The movable framework of the second actuation system 130, constituting the frame 150 and related mechanical components, is mounted between the tabletop 108 and the column 106 (shown in FIG. 1 but removed from view in FIGS. 2A-2D). The movable framework enables at least a part of the tabletop 108, for example the lower torso section 116, to be rotatable about the Trend axis T-T. The Trend axis T-T extends through the movable framework in a transverse direction across the tabletop 108. The Tilt axis X-X extends through the movable framework and is orthogonal to the Trend axis T-T. The Tilt axis X-X is parallel to a central longitudinal axis C-C of the tabletop 108.

A lifting and orienting mechanism for the frame 150 permits a number of different motions that can be selected by the user by controlling the first and second actuators 154, 156 of the second actuation system 130. The particular structural relationship between the first and second actuators 154, 156 and the frame 150 achieves a remarkable variety and range of motions of the frame 150. As an example, the frame 150, and therefore the tabletop 108, can be rotated into either reverse Trend or Trend positions by driving either each of the first and second actuators 154, 156 individually or both of the first and second actuators 154, 156 at the same time in opposite directions, depending upon the initial position of the Trend axis T-T relative to the column 106. Operating two actuators together has the benefit of increasing the speed of Trend movement as a result of a reduction in the distance that each actuator, namely the first and second actuators 154, 156, has to drive for any given change in trend or reverse trend angle.

In particular, the frame 150 can be raised or lowered, with the frame at any given orientation, for example level, i.e. horizontally oriented. This function is achieved by driving both of the first and second actuators 154, 156 simultaneously in the same direction, i.e. extending to raise the elongate element 158 or retracting to lower the elongate element 158, and at the same translational rate. In an example the position of the Trend axis T-T is correspondingly raised or lowered, to raises or lowers a mechanism coupled to the pair of linear guide mechanisms fitted to an outer column element of the extendable column 106.

The frame 150 can therefore be raised or lowered relative to the outer column element of the column 106, and, independently therefrom, the outer column element can be raised or lowered relative to the base 104 of the surgical table 102 since the column 106 is extendable. The cumulative effect is that the vertical motion of the frame 150 relative to the base 104 of the surgical table 102 can combine the vertical motion of the frame 150 relative to the column 106 in an additive sense with vertical motion of the extendable column 106.

In addition, the frame 150 can be raised or lowered so as to orient the frame at any given orientation relative to the horizontal, i.e. to a reverse Trend orientation (with the lower torso section 116 coupled to the frame 150 inclined so that the head section 112 of the tabletop 108 is above the leg sections 118 of the tabletop 108) or to a Trend orientation (with the lower torso section 116 coupled to the frame 150 inclined so that the head section 112 of the tabletop 108 is below the leg sections 118 of the tabletop 108). This function is achieved, depending upon the start position of the tabletop 108 and the frame 150, by driving one or both of the first and second actuators 154, 156 of the second actuation system 130.

For example, if the tabletop 108 and the frame 150 are initially level relative to the horizontal, as shown in FIG. 2A, the first and second actuators 154, 156 can be driven simultaneously in opposite directions, i.e. extending to raise one elongate element 158 and retracting to lower the other elongate element 158, and at the same translational rate, which may be termed a symmetric mode to achieve a reverse Trend position or a Trend position. When the first and second actuators 154, 156 are driven simultaneously in opposite directions, the vertical position of the Trend axis T-T is stationary, and the frame 150 rotates about the Trend axis T-T. Driving the first and second actuators 154, 156 simultaneously in opposite directions, provides the advantage that very fast Trend, or reverse Trend, movement can be achieved. The enhanced speed is achieved since both sides of the frame 150 are raised or lowered relative to the Trend axis T-T, and so the translational distance that each of the first and second actuators 154, 156 need to extend or retract is minimized for a given change in Trend angle. The reduced actuator driving distance for a given change in Trend angle permits faster Trend movement. Alternatively, the frame 150 can be raised or lowered so as to orient the frame at any given orientation relative to the horizontal, i.e. to a reverse Trend orientation or to a Trend orientation by driving only one of the first and second actuators 154, 156, or by driving both of the first and second actuators 154, 156 in an asymmetric mode, i.e. the first and second actuators 154, 156 are driven in other than an opposite and simultaneous manner.

Some approaches have been attempted to coordinate the use of primary and secondary height actuation in a surgical table provided by the first actuation system 120 (provided in column 106) and the second actuation system 130 (provided in the frame 150), but such approaches often encounter other tradeoffs. First, the exclusive use of a single, primary height actuation system—without a secondary height actuation system—limits the range of tabletop heights that are achievable. Second, sequential activation of primary height actuation and secondary height actuation—e.g. which only uses secondary height actuation after primary height actuation has reached its end-of-travel—creates a noticeable pause in the overall motion as the table slows to a stop and then speeds up as it transitions from primary to secondary height actuation. This may confuse the user about whether the complete range of travel has been reached and extends the time to complete the full range of motion. Third, an approach that always uses primary height and secondary height actuations simultaneously limits the available range of Trend and Reverse Trend. To reach extreme tabletop highs and lows, this limitation is unavoidable, but at intermediate tabletop heights, this approach unnecessarily limits Trend capability. The present motion control system overcomes these and other technical challenges with prior surgical table designs.

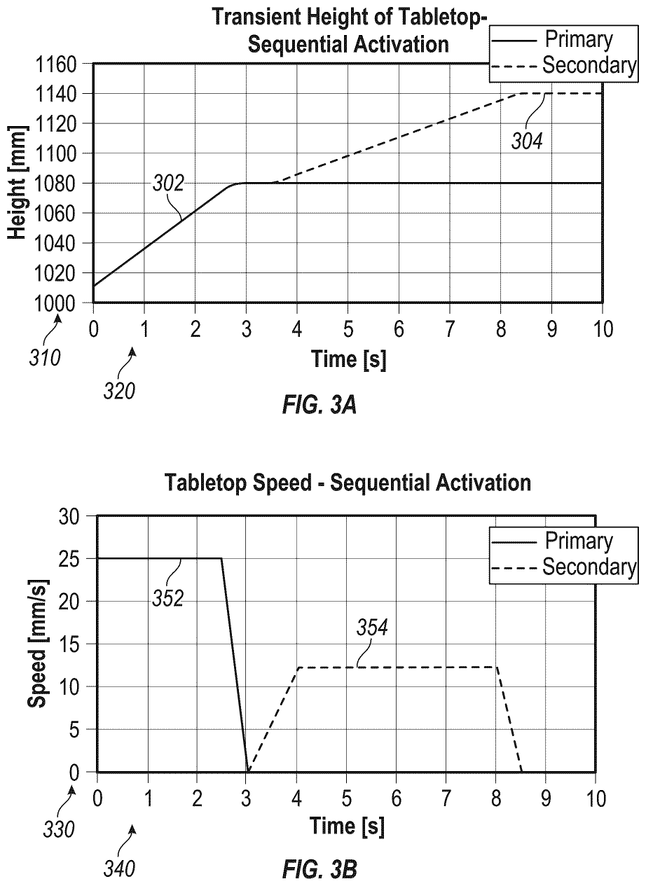

FIG. 3A depicts a graph of height data values showing the transient tabletop height achieved using sequential activation, where a primary actuation system completes travel to its maximum height, before a secondary actuation system is activated to achieve additional height. Here, a vertical axis of the graph is provided with height data 310, in a range from 1000 to 1160 mm; a horizontal axis of the graph is provided by time value data 320, in a range from 0 to 10 seconds. In this graph, the primary actuation system increases table height values 302 until reaching approximately 1080 mm, before the secondary actuation system begins work and table height values 304 continue to increase until a table maximum. Note that around the three-second mark, the tabletop slows considerably and comes to rest briefly before resuming its upward motion. This is noticeable and undesirable behavior, and may be possibly confusing.

FIG. 3B similarly depicts a graph of speed data values showing the tabletop speed achieved using sequential activation, where a primary actuation system slows down to a complete stop before the secondary actuation system is activated. Here, a vertical axis of the graph is provided with speed value data 330, in ranges from 0 to 30 mm/s; a horizontal axis of the graph is provided with time value data 340, in ranges from 0 to 10 seconds. Around the three-second mark, the tabletop speed (shown with the primary height actuation speed values 352) reduces until zero until the secondary actuation system begins work (shown with the secondary height actuation speed values 354).

A motion control system may be adapted to anticipate this transition from primary to secondary height actuation, as the end of travel of primary height approaches and overlaps the deceleration of the primary height actuator and the acceleration of the secondary height actuator to create smooth motion. This can be accomplished by intentionally overlapping the deceleration of one or more actuators and the acceleration of one or more other actuators that control the same overall patient motion, to optimize the trade-off between conflicting performance characteristics. Such an approach is referred to herein as “overlapping activation.”

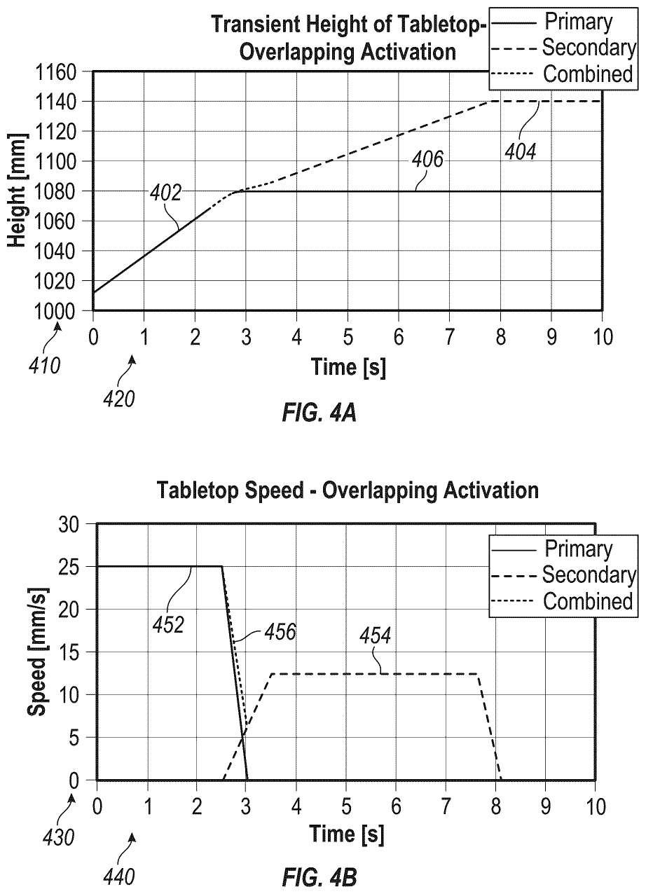

FIG. 4A depicts a graph of height data values showing the transient tabletop height achieved using overlapping activation, where a primary actuation system overlaps its travel with use of a secondary actuation system. Like FIG. 3A, a vertical axis of the graph is provided with height data 410, in a range from 1000 to 1160 mm; a horizontal axis of the graph is provided by time value data 420, in a range from 0 to 10 seconds. In this graph, the primary actuation system increases table height values (at 402) but begins deceleration before reaching the maximum height of the primary actuation system (at 406). Concurrently the secondary actuation system begins to accelerate, increasing until the secondary actuation system reaches a table maximum (at 404) or another stopping point. Unlike the scenario in FIG. 3A, the tabletop continues motion at all times and does not rest when transitioning between the primary and secondary actuation systems.

FIG. 4B similarly depicts a graph of speed data values showing the tabletop speed achieved using overlapping activation, wherein the primary actuation system decelerates while the secondary actuation system accelerates. Like FIG. 3B, a vertical axis of the graph is provided with speed value data 430, in ranges from 0 to 30 mm/s; a horizontal axis of the graph is provided with time value data 440, in ranges from 0 to 10 seconds. In this graph, before the speed of the primary actuation system (at 452) decelerates to zero, the secondary actuation system is activated and begins to accelerate (at 454). As a result, a combined deceleration/acceleration (at 456) allows a transition of the movement to a speed that does not fully stop. Unlike the scenario in FIG. 3B, the tabletop continues motion and does not reach a zero speed when transitioning between the primary and secondary actuation systems.

The use of overlapping activation offers a number of technical and operational advantages. First, it maximizes the range of vertical travel of the tabletop using table configurations that include primary and secondary actuation systems. Second, it maintains as much Trend capability as possible at all heights. Third, it minimizes total travel time over the full range of vertical travel by avoiding unnecessary slow-downs or dwells, and in some examples reduces the amount of time to reach a desired table level. Fourth, it provides smooth motion for patient comfort. Additional aspects of overlapping activation may include dynamically determining when to begin decelerating and accelerating each actuator based on the current height of the table and actuator parameters. Moreover, overlapping activation can be similarly adapted for use in both height increase (raising) and height decrease (lowering), or in other situations where some transition or coordination occurs between two actuation systems.

As will be understood, the implementation of overlapping activation as shown in FIGS. 4A and 4B may be enabled by the controller 140 via its control of multiple components of the surgical table. The controller 140 will control the first actuation system 120 and the column 106, which has a capability for raising and lowering the tabletop beyond that provided by a primary height actuator alone (e.g., via the second actuation system 130). Additionally, the controller 140 can implement the overlapping activation via control of independent, variable speed actuators. Sensors such as shaft encoders (and/or other known measurement devices such as accelerometers) can be used to provide accurate feedback about the speed and position of respective actuators. The controller 140 can implement a known transfer function between encoder counts and tabletop height, to convert a count of the stroke(s) of a respective actuator into the rotation of the tabletop and then into the height of the tabletop. This may be non-linear if the stroke of the actuator is not aligned with the vertical travel of the tabletop, as is the case for the secondary actuation system (Trend actuators).

Further, the controller 140 can be configured with microprocessor-based control logic and coupled to an associated communication network to provide real time control of the actuators. This configuration may be accompanied by limit switches, sensors, or other devices that detect when actuators or the table has reached an end of travel. Finally, the controller 140 can receive commands from user interface devices such as a handset control, backup control mounted on the table, foot controls, and the like, which provide real-time or programmed motion commands from the user into the system. Such commands may be coordinated with known pre-set or pre-programmed configurations of the table (including user-defined configurations, preferences, or settings).

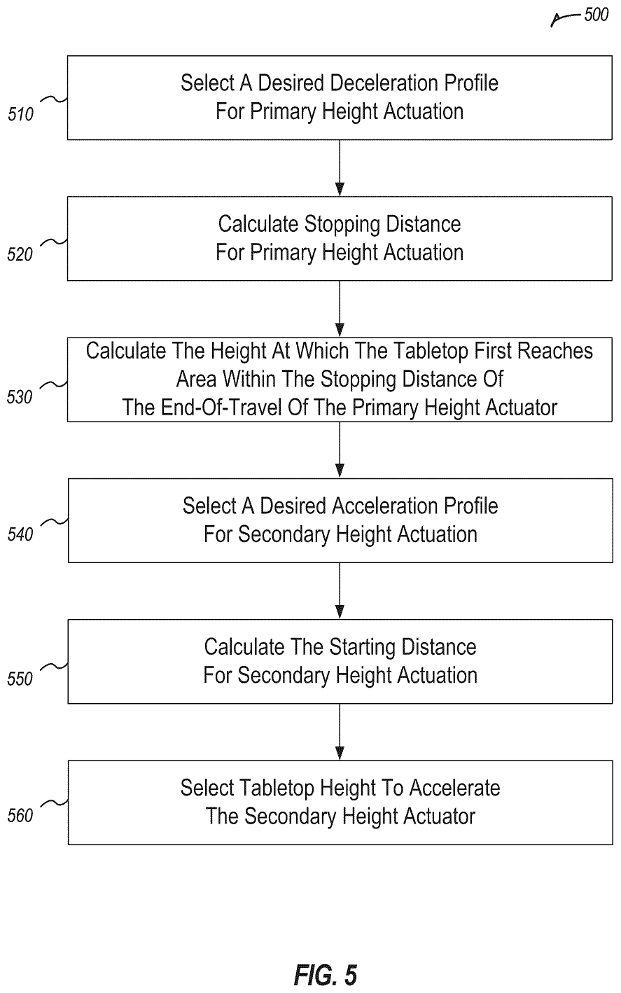

FIG. 5 depicts a flowchart of an example method for initializing settings for overlapping activation of a first actuation system and a second actuation system. An example of a control algorithm that implements this overlapping activation while raising the table is based on the following initial conditions: i) a primary height actuator is moving at its maximum steady speed; ii) the secondary height actuator(s) is not moving; iii) tabletop height is in the range that can be achieved by primary height actuation only; iv) there is no contribution of the secondary height actuator to the overall table height. Accordingly, the use of this control algorithm may be initialized based on table properties and characteristics, and the following profile characteristics.

At block 510: Select a desired deceleration profile for primary height actuation.

At block 520: Calculate the stopping distance for primary height actuation, such as based on the known steady speed of the primary height actuation and the selected deceleration profile.

At block 530: Calculate the height at which the tabletop first reaches an arca within the stopping distance of the end-of-travel of the primary height actuator.

At block 540: Select a desired acceleration profile for secondary height actuation.

At block 550: Calculate the starting distance for secondary height actuation, such as based on the known steady speed of secondary height actuation and the selected acceleration profile.

At block 560: Select a tabletop height at which to begin to accelerate the secondary height actuator, such as based on the calculated starting distance and the known end-of-travel of the primary height actuator.

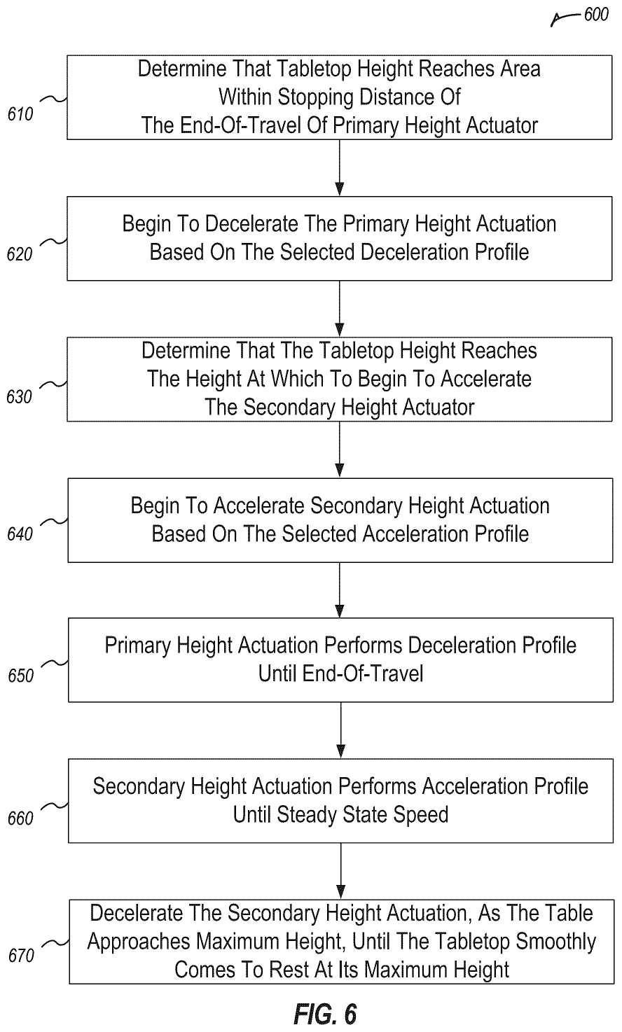

FIG. 6 depicts a flowchart of an example method for transitioning speeds between a first actuation system and a second actuation system in connection with overlapping activation of the systems. This includes the following operations that are executed, in a scenario where the table is raised to its highest elevation.

At block 610 and 620: Determine that the tabletop height reaches an area within the stopping distance of the end of travel of primary height, and begin to decelerate the primary height actuator according to the selected deceleration profile.

At block 630 and 640: Determine that the tabletop height reaches the height at which to begin to accelerate the secondary height actuator(s), and begin to accelerate the secondary height actuator according to the selected acceleration profile.

At block 650: Allow the primary height actuation to complete its deceleration profile until it comes to rest at its end-of-travel.

At block 660: Allow the secondary height actuation to complete its acceleration profile until the secondary actuation system reaches a steady state speed.

At block 670: As the table approaches its maximum height (e.g., maximum table height, or user-specified height), decelerate the secondary height actuation until the tabletop smoothly comes to rest at its maximum height.

Similar reverse operations for acceleration and deceleration may be performed when lowering the table, or when transitioning to a known/user-specified height or position.

In further examples, compensation can be applied during the start of motion of an actuation system, where some “delay” is experienced before an actuator can achieve motion. In a scenario where some startup time is needed for the actuator to achieve motion, then this startup time can be factored into the computation based on the kinematic aspects of motion coordination.

For instance, when lowering the table and transitioning from secondary actuators to the primary actuator, the delay in starting the primary actuator can be considered part of the kinematics. To overcome this delay, the primary actuator can start sooner than calculated in the secondary acceleration time, based on a primary actuator startup time. The primary actuator startup time can be calculated (or re-calculated) upon each motion transfer from the secondary actuation system to the primary actuation system. There may be mechanical reasons for variability in this startup time based on mechanical reasons or demanding use cases (e.g., based on the viscosity of grease that lubricates the lead screw components of the primary actuator, as many repetitions or run time may cause the grease to thin out and reduce its lubricative effectiveness). In an example, the primary actuator startup time is subtracted from the secondary actuator acceleration time. Such startup time may be as small as 500 to 700 milliseconds, but may still have a significant effect on the smoothness of the motion transfer between the primary and secondary actuation systems.

The following table represents height settings and values in a possible implementation example:

TABLE 1

| | |
|---|---|
| Primary | Secondary |
| height actuation | height actuation |

| Stroke | 460 | mm | +I− | |
|---|---|---|---|---|
| | | | 60 mm | |
| Minimum height | 620 | mm | N/A | |
| Maximum height | 1080 | mm | N/A | |
| Maximum steady speed | 2.5 | cm/s | 1.25 | cm/s |
| Constant acceleration | 2.5 | cm/s² | 1.25 | cm/s² |
| Constant deceleration | 5.0 | cm/s² | 2.5 | cm/s² |

In an example, when raising the tabletop, the tabletop height at which to begin to accelerate the secondary height actuators (and decelerate the primary height actuator) is based on the selected stopping distance (end point) for primary height actuation. Likewise, when lowering the tabletop from an extended state of the secondary height actuators, the tabletop height at which to begin to decelerate the secondary height actuators and accelerate the primary height actuator is based on the beginning point of secondary height actuation.

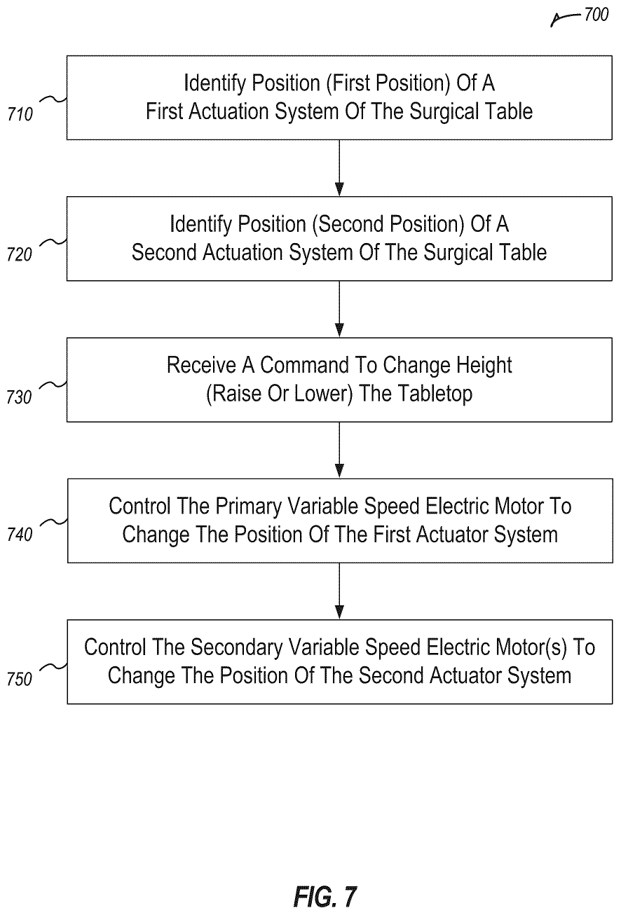

FIG. 7 depicts a flowchart of an example method for controlling positions of a surgical table. This method may be implemented in connection with a hardware and/or software configuration of a surgical table, including with a machine-readable storage medium that provides logic (instructions) for configuring a controller for the surgical table, to perform the following operations. Such a controller may correspond to the controller 140 that is adapted to regulate positions of the primary and secondary actuators, and operable to raise and lower the tabletop based on user control from the user interface control 160.

At block 710, the method includes identifying a position (e.g., a first position) of a first actuation system of the surgical table. In an example, this first actuation system corresponds to the first actuation system 120 and includes at least one primary actuator that is powered with a primary variable speed electric motor to provide primary height actuation. This primary actuator may comprise a linear actuator capable of raising the tabletop to a maximum primary height.

At block 720, the method includes identifying a position (e.g., a second position) of a second actuation system of the surgical table. In an example, this second actuation system corresponds to the second actuation system 130 and includes at least two secondary actuators that are powered respectively with secondary variable speed electric motors to provide secondary height actuation. In a specific example (e.g., discussed with reference to FIGS. 2A to 2D), the secondary actuators are a pair of linear actuators capable of raising the tabletop to a maximum secondary height, and the secondary actuators are further capable of causing rotation of the tabletop relative to a center axis.

At block 730, the method includes receiving a command to change height (e.g., raise or lower) the tabletop. This command may be received from a user interface control communicatively coupled to the controller, as the user interface control receives a specific user command to transition to a particular table mode, or as the user interface control receives an ongoing command (e.g., with an active button press) to raise the tabletop or a user command to lower the tabletop.

At block 740, the method includes controlling the primary variable speed electric motor to change the position of the first actuation system. To raise the table and transition between primary and secondary height actuation, this includes controlling the primary variable speed electric motor based on a primary actuator deceleration profile that decreases a speed of extending the primary actuator while raising the tabletop with the secondary actuators. In an example, this causes the primary actuator deceleration profile to be used until the maximum primary height is reached. For instance, to lower the table and transition between secondary and primary height actuation, this includes controlling the primary variable speed electric motor based on a primary actuator acceleration profile that increases a speed of retracting the primary actuator while lowering the tabletop with the secondary actuators.

At block 750, the method includes controlling the secondary variable speed electric motor(s) to change the position of the second actuation system. To raise the table and transition between primary and secondary height actuation, this includes controlling the secondary variable speed electric motors based on a secondary actuator acceleration profile that increases a speed of extending the secondary actuators while raising the tabletop with the primary actuator. In an example, this provides a speed provided by the secondary actuator acceleration profile that progressively increases to reach a maximum speed of the secondary actuators before the primary actuator reaches the maximum primary height. To lower the table and transition between secondary and primary height actuation, this includes controlling the secondary variable speed electric motors based on a secondary actuator deceleration profile that decreases a speed of retracting the secondary actuators while lowering the tabletop with the primary actuator.

Thus, in a scenario applicable to raise the table, the speed provided by the primary actuator deceleration profile progressively decreases, and the speed provided by the secondary actuator acceleration profile progressively increases before the maximum primary height of the tabletop is reached, to transition from a maximum speed of the primary actuator to a maximum speed of the secondary actuators. The speed used by the primary variable speed electric motor to extend the primary actuator and the speed of the secondary variable speed electric motors to extend the secondary actuators may be based on the positions of the at least one primary actuator and the at least two secondary actuators, as measured with a measurement of strokes of a shaft of a respective actuator. This measurement may be based with use of a measurement of strokes of a shaft of a respective actuator, as discussed above.

In a further example, the primary actuator deceleration profile includes a stopping distance for primary height actuation provided by the primary actuator, with the stopping distance calculated based on a known steady speed of the primary height actuation. Likewise, the secondary actuator acceleration profile includes a starting distance for secondary height actuation provided by the secondary actuators, with the starting distance calculated based on a known steady speed of the secondary height actuation. The timing to begin use of the primary actuator deceleration profile and the secondary actuator acceleration profile may be based on the stopping distance for the primary height actuation provided by the primary actuator.

Further operations may include receiving or implementing a command with the controller to rotate the tabletop about the center axis to a user-controlled angle, based on extension and retraction of respective actuators of the pair of linear actuators. For instance, this may include implementing a user-controlled Trend angle between −45 degrees and 45 degrees. Other operations may be implemented consistent with the examples and drawings herein.

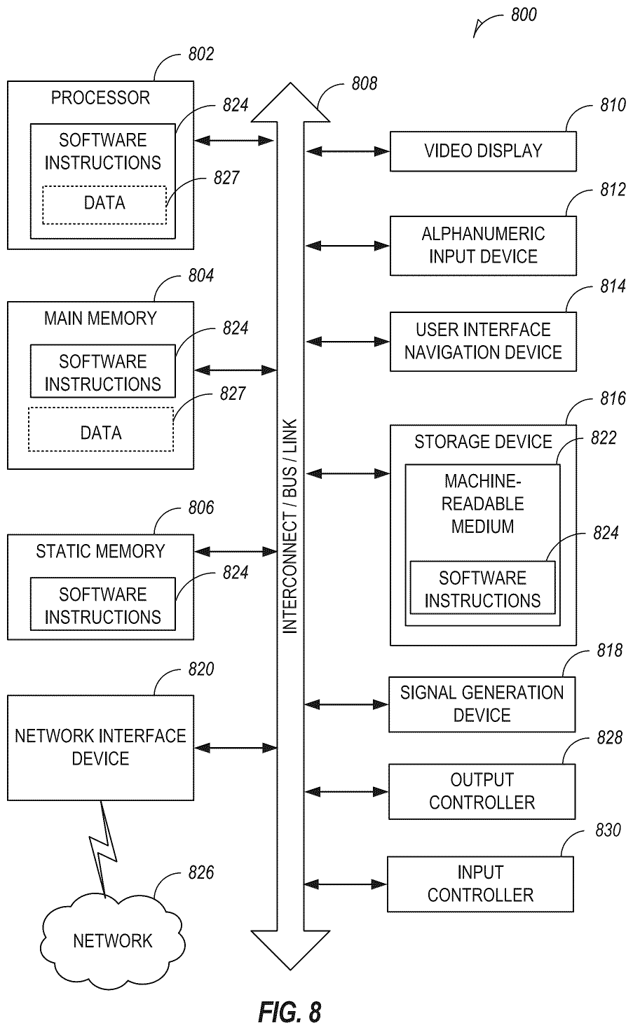

FIG. 8 illustrates a block diagram of an example machine 800 (e.g., computer system, computing device, controller, robot, etc.) that may be programmed into a special purpose machine suitable for implementing one or more embodiments of the actuation or electromechanical control, data processing, user interface, or like aspects disclosed herein. For instance, the controller 140 described above may be embodied by the machine 800, such as in the form of a computer or specialized electronic device that includes sufficient processing power, memory resources, and communications throughput capability to handle the necessary workload placed upon it.

The machine 800 may include a hardware processor 802 (e.g., a central processing unit (CPU), a graphics processing unit (GPU), a hardware processor core, or any combination thereof), a main memory 804 and a static memory 806, some or all of which may communicate with each other via an interconnect, link or bus 808. The machine 800 may further include a display unit 810, an alphanumeric input device 812 and a user interface (UI) navigation device 814. In an example, the display unit 810, alphanumeric input device 812 and navigation device 814 may be a touch screen display. The machine 800 may additionally include a storage device 816 (e.g., drive unit), a signal generation device 818 (e.g., an audio or radio signal generation device), and a network interface device 820 (e.g. for connectivity with a network). The machine 800 may include an output controller 828, such as a serial (e.g., universal serial bus (USB), parallel, or other wired or wireless (e.g., infrared (IR), near field communication (NFC), etc.) connection to communicate or control one or more peripheral devices, and an input controller 830 to connect to more sensors.

The storage device 816 may include a machine readable medium 822 that is non-transitory on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures 827 used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, peer-to-peer (P2P) networks, among others. In an example, the network interface device 820 may include one or more physical jacks or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software.

The devices described herein may be configured to include computer-readable non-transitory media storing computer readable instructions and one or more processors coupled to the memory, and when executing the computer readable instructions configure the machine 800 to perform steps and operations described above for electronic systems or devices (e.g., to display a user interface and receive user interface commands, perform sensing operations from electromechanical and environmental sensors, trigger signals and commands to actuators, etc.). The computer-readable non-transitory media includes all types of computer readable media, including magnetic storage media, optical storage media, flash media and solid-state storage media. It should be further understood that software including one or more computer-executable instructions that facilitate processing and operations as described above with reference to any one or all of steps of the disclosure may be installed in and sold with networked devices (e.g., servers or cloud computing systems) consistent with the disclosure. Alternatively, the software may be obtained and loaded (or, re-loaded/upgraded) from one or more servers and/or cloud computing systems, such as software stored on a server for distribution over the Internet, for example.

Method examples or other operations described herein can be machine or device (e.g., computer, robotic) implemented at least in part. The components of the illustrative devices, systems and methods employed in accordance with the illustrated embodiments may be implemented, at least in part, in digital electronic circuitry, analog electronic circuitry, or in computer hardware, firmware, software, or in combinations of them. These components may be implemented, for example, as a computing program product such as a computing program, program code or computer instructions tangibly embodied in an information carrier, or in a machine-readable storage device, for execution by, or to control the operation of, a data processing apparatus such as a programmable processor, a computer, or multiple computers. A computing program may be written in any form of programming language, including compiled or interpreted languages, and it may be deployed in any form, including as a stand-alone program or as a module, component, subroutine, or other unit suitable for use in a computing environment. Also, functional programs, codes, and code segments for accomplishing the techniques described herein may be easily construed as within the scope of the present disclosure by programmers skilled in the art. Method steps associated with the illustrative embodiments may be performed by one or more programmable processors executing a computing program, code or instructions to perform functions (e.g., by operating on input data and/or generating an output). Method steps may also be performed by, and apparatus may be implemented as, special purpose logic circuitry, e.g., an FPGA (field programmable gate array) or an ASIC (application-specific integrated circuit), for example.

Thus, in implementation in a controller or other machine for a surgical table, various logical blocks, modules, and circuits described in connection with the embodiments disclosed herein may be implemented or performed with a general-purpose processor, a digital signal processor (DSP), an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Processors suitable for the execution of a computing program include, by way of example, both general and special purpose microprocessors, and any one or more processors of any kind of digital computer. Information carriers suitable for embodying computing program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, etc.). The processor and the memory may be supplemented by or incorporated in special purpose logic circuitry.

As used herein, “machine-readable medium” or “machine-readable storage medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” or “machine-readable storage medium” should be taken to include a single medium or multiple media (e.g., a centralized or distributed database, or associated caches and servers) able to store processor instructions. The term “machine-readable medium” or “machine-readable storage medium” shall also be taken to include any medium, or combination of multiple media, which is capable of storing instructions for execution by one or more processors (or other processing circuitry), such that the instructions, when executed by one or more processors cause the one or more processors to perform any one or more of the methodologies described herein. Accordingly, a “machine-readable medium” or “machine-readable storage medium” refers to a single storage apparatus or device, as well as “cloud-based” storage systems or storage networks that include multiple storage apparatus or devices. A non-transitory “machine-readable medium” or “machine-readable storage medium” as used herein excludes signals per se.

Example 1 is a surgical table, comprising: a tabletop; a first actuation system coupled to the tabletop, the first actuation system including at least one primary actuator that is powered with a primary variable speed electric motor; a second actuation system coupled to the tabletop, the second actuation system including at least two secondary actuators that are powered respectively with secondary variable speed electric motors; and a controller adapted to regulate positions of the primary and secondary actuators, wherein the controller is operable to raise the tabletop with logic to: control the primary variable speed electric motor based on a primary actuator deceleration profile that decreases a speed of extending the primary actuator while raising the tabletop with the secondary actuators; and control the secondary variable speed electric motors based on a secondary actuator acceleration profile that increases a speed of extending the secondary actuators while raising the tabletop with the primary actuator.

In Example 2, the subject matter of Example 1 optionally includes subject matter where the primary actuator is a linear actuator capable of raising the tabletop to a maximum primary height, and wherein the primary actuator deceleration profile is used until the maximum primary height is reached.

In Example 3, the subject matter of Example 2 optionally includes subject matter where a speed provided by the secondary actuator acceleration profile progressively increases to reach a maximum speed of the secondary actuators before the primary actuator reaches the maximum primary height.

In Example 4, the subject matter of any one or more of Examples 2-3 optionally include subject matter where a speed provided by the primary actuator deceleration profile progressively decreases, and wherein a speed provided by the secondary actuator acceleration profile progressively increases before the maximum primary height of the tabletop is reached, to transition from a maximum speed of the primary actuator to a maximum speed of the secondary actuators.

In Example 5, the subject matter of any one or more of Examples 1-4 optionally include subject matter where the controller is operable to lower the tabletop with logic to: control the secondary variable speed electric motors based on a secondary actuator deceleration profile that decreases a speed of retracting the secondary actuators while lowering the tabletop with the primary actuator; and control the primary variable speed electric motor based on a primary actuator acceleration profile that increases a speed of retracting the primary actuator while lowering the tabletop with the secondary actuators.

In Example 6, the subject matter of any one or more of Examples 1-5 optionally include subject matter where the primary actuator deceleration profile includes a stopping distance for primary height actuation provided by the primary actuator, the stopping distance calculated based on a known steady speed of the primary height actuation, and wherein the secondary actuator acceleration profile includes a starting distance for secondary height actuation provided by the secondary actuators, the starting distance calculated based on a known steady speed of the secondary height actuation.

In Example 7, the subject matter of Example 6 optionally includes subject matter where a timing to begin use of the primary actuator deceleration profile and the secondary actuator acceleration profile is based on the stopping distance for the primary height actuation provided by the primary actuator.

In Example 8, the subject matter of any one or more of Examples 1-7 optionally include subject matter where the speed of extending the primary actuator and the speed of extending the secondary actuators are further based on a current height of the tabletop and respective characteristics of the primary actuator and the secondary actuators.

In Example 9, the subject matter of any one or more of Examples 1-8 optionally include subject matter where the secondary actuators are a pair of linear actuators capable of raising the tabletop to a maximum secondary height, and wherein the secondary actuators are further capable of causing rotation of the tabletop relative to a center axis.

In Example 10, the subject matter of Example 9 optionally includes subject matter

where the controller is operable to change an angle of the tabletop using logic configured to: rotate the tabletop about the center axis to a user-controlled angle, based on extension and retraction of respective actuators of the pair of linear actuators.

In Example 11, the subject matter of Example 10 optionally includes the user-controlled angle between −45 degrees and 45 degrees.

In Example 12, the subject matter of any one or more of Examples 1-11 optionally include subject matter where a speed used by the primary variable speed electric motor to extend the primary actuator and a speed of the secondary variable speed electric motors to extend the secondary actuators is based on the positions of the at least one primary actuator and the at least two secondary actuators.

In Example 13, the subject matter of Example 12 optionally includes subject matter where the controller is further adapted to determine the positions of the at least one primary actuator and the at least two secondary actuators based on a measurement of strokes of a shaft of a respective actuator.

In Example 14, the subject matter of Example 13 optionally includes subject

matter where the measurement of strokes is measured with a shaft encoder sensor of the respective actuator.

In Example 15, the subject matter of any one or more of Examples 1-14 optionally include a user interface control communicatively coupled to the controller, the user interface control to receive a user command to raise the tabletop or a user command to lower the tabletop.

Example 16 is a method for controlling positions of a surgical table, comprising: identifying a first position of a first actuation system of the surgical table, the first actuation system including at least one primary actuator that is powered with a primary variable speed electric motor, wherein the primary actuator is coupled to a tabletop of the surgical table; identifying a second position of a second actuation system of the surgical table, the second actuation system including at least two secondary actuators that are powered respectively with secondary variable speed electric motors, wherein the secondary actuators are coupled to the tabletop of the surgical table; receiving a command to raise the tabletop; controlling the primary variable speed electric motor to change the first position of the first actuation system, based on a primary actuator deceleration profile that decreases a speed of extending the primary actuator while raising the tabletop with the secondary actuators; and controlling the secondary variable speed electric motors to change the second position of the second actuation system, based on a secondary actuator acceleration profile that increases a speed of extending the secondary actuators while raising the tabletop with the primary actuator.

In Example 17, the subject matter of Example 16 optionally includes subject matter where the primary actuator is a linear actuator capable of raising the tabletop to a maximum primary height, and wherein the primary actuator deceleration profile is used until the maximum primary height is reached.

In Example 18, the subject matter of Example 17 optionally includes subject matter where a speed provided by the secondary actuator acceleration profile progressively increases to reach a maximum speed of the secondary actuators before the primary actuator reaches the maximum primary height.

In Example 19, the subject matter of any one or more of Examples 17-18 optionally include subject matter where a speed provided by the primary actuator deceleration profile progressively decreases, and wherein a speed provided by the secondary actuator acceleration profile progressively increases before the maximum primary height of the tabletop is reached, to transition from a maximum speed of the primary actuator to a maximum speed of the secondary actuators.

In Example 20, the subject matter of any one or more of Examples 16-19 optionally include controlling the secondary variable speed electric motors based on a secondary actuator deceleration profile that decreases a speed of retracting the secondary actuators while lowering the tabletop with the primary actuator; and controlling the primary variable speed electric motor based on a primary actuator acceleration profile that increases a speed of retracting the primary actuator while lowering the tabletop with the secondary actuators.

In Example 21, the subject matter of any one or more of Examples 16-20 optionally include subject matter where the primary actuator deceleration profile includes a stopping distance for primary height actuation provided by the primary actuator, the stopping distance calculated based on a known steady speed of the primary height actuation, and wherein the secondary actuator acceleration profile includes a starting distance for secondary height actuation provided by the secondary actuators, the starting distance calculated based on a known steady speed of the secondary height actuation.

In Example 22, the subject matter of Example 21 optionally includes subject matter where a timing to begin use of the primary actuator deceleration profile and the secondary actuator acceleration profile is based on the stopping distance for the primary height actuation provided by the primary actuator.

In Example 23, the subject matter of any one or more of Examples 16-22 optionally include subject matter where the speed of extending the primary actuator and the speed of extending the secondary actuators are further based on a current height of the tabletop and respective characteristics of the primary actuator and the secondary actuators.

In Example 24, the subject matter of any one or more of Examples 16-23 optionally include subject matter where the secondary actuators are a pair of linear actuators capable of raising the tabletop to a maximum secondary height, and wherein the secondary actuators are further capable of causing rotation of the tabletop relative to a center axis.

In Example 25, the subject matter of Example 24 optionally includes subject

matter where an angle of the tabletop is changed by rotating the tabletop about the center axis to a user-controlled angle, based on extension and retraction of respective actuators of the pair of linear actuators.

In Example 26, the subject matter of Example 25 optionally includes the user-controlled angle between −45 degrees and 45 degrees.

In Example 27, the subject matter of any one or more of Examples 16-26 optionally include subject matter where a speed used by the primary variable speed electric motor to extend the primary actuator and a speed of the secondary variable speed electric motors to extend the secondary actuators is based on the positions of the at least one primary actuator and the at least two secondary actuators.

In Example 28, the subject matter of Example 27 optionally includes subject matter where the positions of the at least one primary actuator and the at least two secondary actuators are determined based on a measurement of strokes of a shaft of a respective actuator.

In Example 29, the subject matter of Example 28 optionally includes subject

matter where the measurement of strokes is measured with a shaft encoder sensor of the respective actuator.

In Example 30, the subject matter of any one or more of Examples 16-29 optionally include subject matter where the command to raise the tabletop is provided from a user interface control.

Example 31 is a non-transitory machine-readable storage medium comprising instructions, which when executed by circuitry of a controller for a surgical table, causes the circuitry to perform operations of any one or more of the Examples 16-29 for raising and/or lowering the surgical table, including operations that: determine a first position of a first actuation system of the surgical table, the first actuation system including at least one primary actuator that is powered with a primary variable speed electric motor, wherein the primary actuator is coupled to a tabletop of the surgical table; determine a second position of a second actuation system of the surgical table, the second actuation system including at least two secondary actuators that are powered respectively with secondary variable speed electric motors, wherein the secondary actuators are coupled to the tabletop of the surgical table; and change the first position and the second position of the primary and secondary actuators respectively, in response to a command to raise the tabletop, with operations to: control the primary variable speed electric motor based on a primary actuator deceleration profile that decreases a speed of extending the primary actuator while raising the tabletop with the secondary actuators; and control the secondary variable speed electric motors based on a secondary actuator acceleration profile that increases a speed of extending the secondary actuators while raising the tabletop with the primary actuator.

Example 32 is a surgical table, comprising: a tabletop; a first actuation system coupled to the tabletop, the first actuation system including at least one primary actuator that is powered with a primary variable speed electric motor; a second actuation system coupled to the tabletop, the second actuation system including at least two secondary actuators that are powered respectively with secondary variable speed electric motors; and a controller adapted to regulate positions of the primary and secondary actuators, wherein the controller is operable to lower the tabletop with logic to: control the primary variable speed electric motor based on a primary actuator acceleration profile that increases a speed of retracting the primary actuator while lowering the tabletop with the secondary actuators; and control the secondary variable speed electric motors based on a secondary actuator deceleration profile that decreases a speed of retracting the secondary actuators while lowering the tabletop with the primary actuator.

Example 33 is a method for controlling positions of a surgical table, comprising: identifying a first position of a first actuation system of the surgical table, the first actuation system including at least one primary actuator that is powered with a primary variable speed electric motor, wherein the primary actuator is coupled to a tabletop of the surgical table; identifying a second position of a second actuation system of the surgical table, the second actuation system including at least two secondary actuators that are powered respectively with secondary variable speed electric motors, wherein the secondary actuators are coupled to the tabletop of the surgical table; receiving a command to lower the tabletop; controlling the primary variable speed electric motor to change the first position of the first actuation system, based on a primary actuator acceleration profile that increases a speed of retracting the primary actuator while lowering the tabletop with the secondary actuators; and controlling the secondary variable speed electric motors to change the second position of the second actuation system, based on a secondary actuator deceleration profile that decreases a speed of retracting the secondary actuators while lowering the tabletop with the primary actuator.

Example 34 is a non-transitory machine-readable storage medium comprising instructions, which when executed by circuitry of a controller for a surgical table, causes the circuitry to perform operations of any one or more of the Examples 16-29 for raising and/or lowering the surgical table, including operations that: determine a first position of a first actuation system of the surgical table, the first actuation system including at least one primary actuator that is powered with a primary variable speed electric motor, wherein the primary actuator is coupled to a tabletop of the surgical table; determine a second position of a second actuation system of the surgical table, the second actuation system including at least two secondary actuators that are powered respectively with secondary variable speed electric motors, wherein the secondary actuators are coupled to the tabletop of the surgical table; and change the first position and the second position of the primary and secondary actuators respectively, in response to a command to lower the tabletop, with operations to: control the primary variable speed electric motor based on a primary actuator acceleration profile that increases a speed of retracting the primary actuator while lowering the tabletop with the secondary actuators; and control the secondary variable speed electric motors based on a secondary actuator deceleration profile that decreases a speed of retracting the secondary actuators while lowering the tabletop with the primary actuator.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A surgical table, comprising:
a tabletop;
a first actuation system coupled to the tabletop, the first actuation system including at least one primary actuator that is powered with a primary variable speed electric motor;
a second actuation system coupled to the tabletop, the second actuation system including at least two secondary actuators that are powered respectively with secondary variable speed electric motors; and
a controller adapted to regulate positions of the primary and secondary actuators, wherein the controller is operable to raise the tabletop with logic to:
control the primary variable speed electric motor based on a primary actuator deceleration profile that decreases a speed of extending the primary actuator while raising the tabletop with the secondary actuators; and
control the secondary variable speed electric motors based on a secondary actuator acceleration profile that increases a speed of extending the secondary actuators while raising the tabletop with the primary actuator.

2. The surgical table of claim 1, wherein the primary actuator is a linear actuator capable of raising the tabletop to a maximum primary height, and wherein the primary actuator deceleration profile is used until the maximum primary height is reached.

3. The surgical table of claim 2, wherein a speed provided by the secondary actuator acceleration profile progressively increases to reach a maximum speed of the secondary actuators before the primary actuator reaches the maximum primary height.

4. The surgical table of claim 2, wherein a speed provided by the primary actuator deceleration profile progressively decreases, and wherein a speed provided by the secondary actuator acceleration profile progressively increases before the maximum primary height of the tabletop is reached, to transition from a maximum speed of the primary actuator to a maximum speed of the secondary actuators.

5. The surgical table of claim 1, wherein the controller is operable to lower the tabletop with logic to:
control the secondary variable speed electric motors based on a secondary actuator deceleration profile that decreases a speed of retracting the secondary actuators while lowering the tabletop with the primary actuator; and
control the primary variable speed electric motor based on a primary actuator acceleration profile that increases a speed of retracting the primary actuator while lowering the tabletop with the secondary actuators.

6. The surgical table of claim 1, wherein the primary actuator deceleration profile includes a stopping distance for primary height actuation provided by the primary actuator, the stopping distance calculated based on a known steady speed of the primary height actuation, and
wherein the secondary actuator acceleration profile includes a starting distance for secondary height actuation provided by the secondary actuators, the starting distance calculated based on a known steady speed of the secondary height actuation.

7. The surgical table of claim 6, wherein a timing to begin use of the primary actuator deceleration profile and the secondary actuator acceleration profile is based on the stopping distance for the primary height actuation provided by the primary actuator.

8. The surgical table of claim 1, wherein the speed of extending the primary actuator and the speed of extending the secondary actuators are further based on a current height of the tabletop and respective characteristics of the primary actuator and the secondary actuators.

9. The surgical table of claim 1, wherein the secondary actuators are a pair of linear actuators capable of raising the tabletop to a maximum secondary height, and wherein the secondary actuators are further capable of causing rotation of the tabletop relative to a center axis.

10. The surgical table of claim 9, wherein the controller is operable to change an angle of the tabletop using logic configured to:
rotate the tabletop about the center axis to a user-controlled angle, based on extension and retraction of respective actuators of the pair of linear actuators.

11. The surgical table of claim 10, wherein the user-controlled angle is between −45 degrees and 45 degrees.

12. The surgical table of claim 1, wherein a speed used by the primary variable speed electric motor to extend the primary actuator and a speed of the secondary variable speed electric motors to extend the secondary actuators is based on the positions of the at least one primary actuator and the at least two secondary actuators.

13. The surgical table of claim 12, wherein the controller is further adapted to determine the positions of the at least one primary actuator and the at least two secondary actuators based on a measurement of strokes of a shaft of a respective actuator.

14. The surgical table of claim 13, wherein the measurement of strokes is measured with a shaft encoder sensor of the respective actuator.

15. The surgical table of claim 1, further comprising:
a user interface control communicatively coupled to the controller, the user interface control to receive a user command to raise the tabletop or a user command to lower the tabletop.

16. A method for controlling positions of a surgical table, comprising:
identifying a first position of a first actuation system of the surgical table, the first actuation system including at least one primary actuator that is powered with a primary variable speed electric motor, wherein the primary actuator is coupled to a tabletop of the surgical table;
identifying a second position of a second actuation system of the surgical table, the second actuation system including at least two secondary actuators that are powered respectively with secondary variable speed electric motors, wherein the secondary actuators are coupled to the tabletop of the surgical table;
receiving a command to raise the tabletop;
controlling the primary variable speed electric motor to change the first position of the first actuation system, based on a primary actuator deceleration profile that decreases a speed of extending the primary actuator while raising the tabletop with the secondary actuators; and
controlling the secondary variable speed electric motors to change the second position of the second actuation system, based on a secondary actuator acceleration profile that increases a speed of extending the secondary actuators while raising the tabletop with the primary actuator.

17. The method of claim 16, wherein the primary actuator is a linear actuator capable of raising the tabletop to a maximum primary height, and wherein the primary actuator deceleration profile is used until the maximum primary height is reached.

18. The method of claim 17, wherein a speed provided by the primary actuator deceleration profile progressively decreases, and wherein a speed provided by the secondary actuator acceleration profile progressively increases before the maximum primary height of the tabletop is reached, to transition from a maximum speed of the primary actuator to a maximum speed of the secondary actuators.

19. The method of claim 16, further comprising:
controlling the secondary variable speed electric motors based on a secondary actuator deceleration profile that decreases a speed of retracting the secondary actuators while lowering the tabletop with the primary actuator; and
controlling the primary variable speed electric motor based on a primary actuator acceleration profile that increases a speed of retracting the primary actuator while lowering the tabletop with the secondary actuators.

20. A non-transitory machine-readable storage medium comprising instructions, which when executed by circuitry of a controller for a surgical table, causes the circuitry to perform operations that:
determine a first position of a first actuation system of the surgical table, the first actuation system including at least one primary actuator that is powered with a primary variable speed electric motor, wherein the primary actuator is coupled to a tabletop of the surgical table;
determine a second position of a second actuation system of the surgical table, the second actuation system including at least two secondary actuators that are powered respectively with secondary variable speed electric motors, wherein the secondary actuators are coupled to the tabletop of the surgical table; and
change the first position and the second position of the primary and secondary actuators respectively, in response to a command to raise the tabletop, with operations to:
control the primary variable speed electric motor based on a primary actuator deceleration profile that decreases a speed of extending the primary actuator while raising the tabletop with the secondary actuators; and
control the secondary variable speed electric motors based on a secondary actuator acceleration profile that increases a speed of extending the secondary actuators while raising the tabletop with the primary actuator.
